(19) United States
(12) Patent Application Publication
(10) Pub. No.: US 2025/0159335 A1
(43) Pub. Date: May 15, 2025

(54) ELECTRONIC DEVICE AND IMAGE CAPTURING CONTROL METHOD THEREOF

(71) Applicant: ASUSTeK COMPUTER INC., Taipei City (TW)

(72) Inventor: Chun-Yen Liao, Taipei City (TW)

(73) Assignee: ASUSTeK COMPUTER INC., Taipei City (TW)

(21) Appl. No.: 18/929,551

(22) Filed: Oct. 28, 2024

(30) Foreign Application Priority Data
Nov. 10, 2023 (CN) 202311494903.5

(51) Int. Cl. H04N 23/60; H04N 23/62

(52) U.S. Cl. CPC H04N 23/64; H04N 23/62

(57) ABSTRACT

Disclosed are an electronic device and an image capturing control method thereof. The image capturing control method includes: providing a plurality of candidate capturing algorithms; setting one of the candidate capturing algorithms as a selected capturing algorithm; setting a plurality of algorithm parameters of the selected capturing algorithm according to the first input command; performing an image capturing operation of N image frames to obtain a plurality of captured images according to these algorithm parameters; and performing an image processing operation on the captured image according to the selected capturing algorithm to generate an output image.

### CROSS-REFERENCE TO RELATED APPLICATION

This application claims the priority benefit of China application serial no. 202311494903.5, filed on Nov. 10, 2023. The entirety of the above-mentioned patent application is hereby incorporated by reference herein and made a part of this specification.

### BACKGROUND

### Technical Field

The present disclosure relates to an electronic device and an image capturing control method thereof, and in particular to an electronic device that may automatically set a selected algorithm and algorithm parameters and an image capturing control method thereof.

### Description of Related Art

Currently, algorithms for image capturing used by electronic devices (such as mobile phones) are automatically selected by the electronic device based on the current scene. For example, when taking a picture in a dark place, the night capturing algorithm will be triggered, and when taking a picture at a bright place, the composite algorithm for capturing multiple images with high dynamic range (HDR) will be triggered. These algorithms are all determined by automatic detection of scenes, and users can only accept the results. As a result, user's creativity will be limited and they will be unable to capture creative images.

### SUMMARY

The present disclosure is directed to an electronic device and an image capturing control method thereof. By providing the user with more setting permissions, an output image of a special style may be generated.

According to an embodiment of the present disclosure, the image capturing control method includes: providing a plurality of candidate capturing algorithms; setting one of the candidate capturing algorithms as a selected capturing algorithm; setting a plurality of algorithm parameters of the selected capturing algorithm according to the first input command; performing an image capturing operation of N image frames to obtain a plurality of captured images according to these algorithm parameters; and performing an image processing operation on the captured image according to the selected capturing algorithm to generate an output image.

According to an embodiment of the disclosure, an electronic device includes an image capturing device and a controller. The controller is coupled to the image capturing device. The controller is disposed to provide a plurality of candidate capturing algorithms; set one of the candidate capturing algorithms as a selected capturing algorithm; set a plurality of algorithm parameters of the selected capturing algorithm according to the first input command; perform an image capturing operation of N image frames through the image capturing device to obtain a plurality of captured images according to these algorithm parameters; and perform an image processing operation on the captured image according to the selected capturing algorithm to generate an output image.

Based on the above, in the image capturing control method of the present disclosure, the selected capturing algorithm is not limited to the state of the capturing scene, and may be selected by the user. Furthermore, the users may set multiple algorithm parameters of the selected capturing algorithm by themselves, and the electronic device may perform image capturing operation and image processing operation of the captured image according to the set selected capturing algorithm and algorithm parameters, thereby generating an output image. In this way, image capturing operation will not be limited to the default conditions of the electronic device, and users may capture more creative output images.

### BRIEF DESCRIPTION OF THE DRAWINGS

FIG. 1 is a flow chart of an image capturing control method according to an embodiment of the present disclosure.

FIG. 2 is a flow chart of an image capturing control method according to another embodiment of the present disclosure.

FIG. 3 is a flow chart of an image capturing control method according to yet another embodiment of the present disclosure.

FIG. 4 is a schematic diagram of an electronic device according to an embodiment of the present disclosure.

### DESCRIPTION OF THE EMBODIMENTS

Reference will now be made in detail to the exemplary embodiments of the present disclosure, examples of which are illustrated in the accompanying drawings. Whenever possible, the same reference numbers are used in the drawings and descriptions to refer to the same or similar parts.

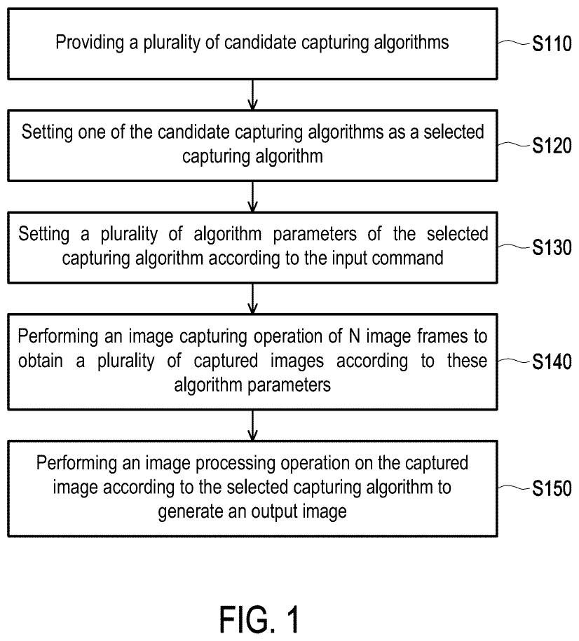

Please refer to FIG. 1, which is a flow chart of an image capturing control method according to an embodiment of the present disclosure. In step S110, the electronic device that performs the image capturing operation may provide a plurality of candidate capturing algorithms. The electronic device may also set one of the candidate capturing algorithms as the selected capturing algorithm in step S120, wherein the electronic device may provide a menu with multiple candidate capturing algorithms for the user to select. Users may perform selection operation through an input command. In this way, the electronic device may set one of the plurality of candidate capturing algorithms as the selected capturing algorithm according to the user's input command.

Then, the electronic device may further set the algorithm parameters of the selected capturing algorithm. The electronic device may also provide a menu for multiple algorithm parameters of the selected capturing algorithm, so that the user may adjust the algorithm parameters through an input command. In step S130, the electronic device may set multiple algorithm parameters of the selected capturing algorithm according to the input command.

In step S140, the electronic device may perform image capturing operation of N image frames according to the set algorithm parameters, and thereby obtaining multiple captured images. Moreover, in step S150, the electronic device may further perform an image processing operation on the captured image according to the algorithm parameters, perform image composition on the processed captured image, and thereby generating an output image.

In this embodiment, the electronic device allows the user to select and set the selected capturing algorithm and related algorithm parameters. In this way, users may have more control over image capturing operation and take photos with a special style.

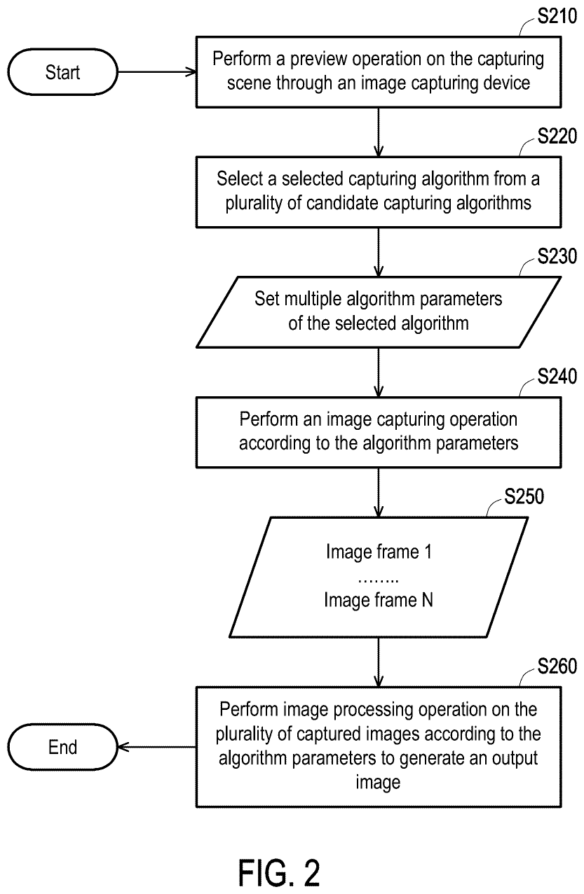

Please refer to FIG. 2 below. FIG. 2 is a flow chart of an image capturing control method according to another embodiment of the present disclosure. The image capturing operation in this embodiment may be performed by an electronic device, wherein the electronic device has a controller and an image capturing device. In step S210, the controller may control the image capturing device to perform a preview operation on the capturing scene. Further, the controller may generate a plurality of candidate capturing algorithms based on the capturing scene obtained from the preview operation. The controller may also provide candidate capturing algorithms for the user to select, and in step S220, a selected capturing algorithm is selected from a plurality of candidate capturing algorithms according to the user's input command. In detail, the electronic device may have a display interface and an input interface. The controller may display information about the available candidate capturing algorithms through the display interface. The controller may also receive input commands from the user through the input interface, and then set the selected capturing algorithm according to the input command.

Incidentally, in this embodiment, in order not to limit the user's creativity, the controller may display information about all available candidate capturing algorithms on the display interface. On the other hand, the controller may, for example, perform a display operation on the candidate capturing algorithms according to the brightness of the capturing scene, and display the order of the candidate capturing algorithms recommended by the electronic device for this capturing scene through the arrangement order of the information of multiple capturing algorithms on the display interface.

To put it simply, the controller may display the relevant information of the most recommended candidate capturing algorithm at the top, and display the information related to the second recommended and the unrecommended candidate capturing algorithms in sequence at lower positions. Of course, through the user's settings, the controller may also display the information related to the least recommended candidate capturing algorithm at the top, and display the information related to the second recommended and the most recommended candidate capturing algorithm in sequence at lower positions.

Next, in step S230, the controller may set multiple algorithm parameters of the selected algorithm. In details, the controller may perform display operation on the algorithm parameters of the selected capturing algorithm through the display interface. In addition, users may perform input operation on various algorithm parameters through the input interface. Each algorithm parameter displayed on the display interface may have a default value, and the user may adjust any algorithm parameter through the input interface. The controller may complete the setting operation on the multiple algorithm parameters of the selected capturing algorithm according to the user's input command.

In step S240, the controller may use the image capturing device to perform an image capturing operation according to the algorithm parameters, and obtain captured images corresponding to a plurality of image frames (image frame 1 to image frame N) in step S250. In step S260, the controller may perform image processing operation on the plurality of captured images according to the algorithm parameters to generate an output image, and end the process.

Incidentally, in this embodiment, the candidate capturing algorithm includes at least one of a high dynamic range (HDR) algorithm and a night capturing algorithm. Corresponding to the high dynamic range algorithm, the algorithm parameters include the number of captured images corresponding to multiple exposure values. The multiple exposure values are, for example, positive exposure values, zero exposure values, and negative exposure values.

It is worth noting that in the embodiment of the present disclosure, after step S260, one additional level of algorithm may be superimposed. For example, when the selected algorithm is a high dynamic range algorithm, an additional red-eye removal algorithm is added to further improve the quality of the output image. In the embodiment of the present disclosure, after the image processing operation is performed on the multiple image frames, one or more image processing operations for a single image frame may be concatenated, and the method is not limited to the above red-eye removal algorithm.

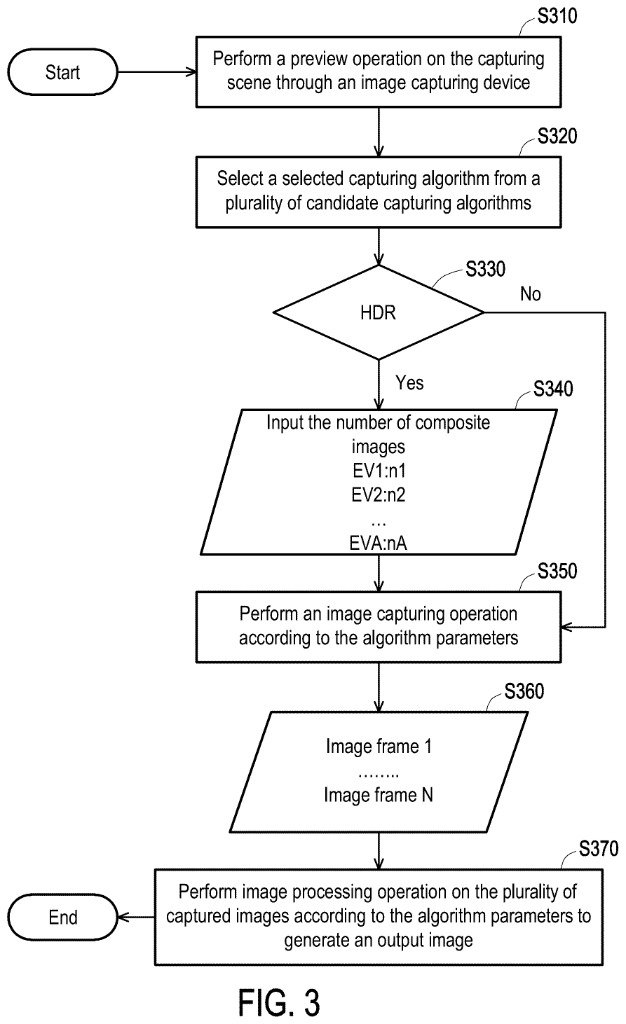

Please refer to FIG. 3 below. FIG. 3 is a flow chart of an image capturing control method according to another embodiment of the present disclosure. The image capturing operation in this embodiment may also be performed by an electronic device having a controller, a display interface, an input interface, and an image capturing device. In step S310, the controller may control the image capturing device to perform a preview operation on the capturing scene. Further, the controller may generate a plurality of candidate capturing algorithms based on the capturing scene obtained from the preview operation. The controller may also provide candidate capturing algorithms for the user to select, and in step S320, a selected capturing algorithm is selected from multiple candidate capturing algorithms according to the user's input command.

Next, in step S330, the controller may determine whether the selected capturing algorithm is a high dynamic range (HDR) algorithm. If the controller determines that the capturing algorithm is the HDR algorithm, step S340 may be executed; conversely, if the controller determines that the capturing algorithm is not the HDR algorithm, step S350 may be executed.

In step S340, the controller may set multiple algorithm parameters of the HDR algorithm according to the input command, such as n1 to nA of captured images respectively corresponding to multiple exposure values EV1 to EVA.

In step S350, the controller may use the image capturing device to perform an image capturing operation according to the algorithm parameters. In this embodiment, the controller may control the image capturing device to capture n1 to nA captured images under multiple exposure values EV1 to EVA. In this way, in step S360, captured images corresponding to multiple image frames (image frame 1 to image frame N) may be obtained.

In step S370, the controller may perform image processing operation on the plurality of captured images according to the algorithm parameters to generate an output image, and end the process.

It is worth noting that in the embodiment of the present disclosure, after step S370, based on the selected algorithm being a high dynamic range algorithm, an additional red-eye removal algorithm may be added to further improve the quality of the output image. Similarly, in the embodiment of the present disclosure, after performing the image processing operations on the multiple image frames, one or more image processing operations on a single image frame may also be concatenated, and the method is not limited to the red-eye removal algorithm.

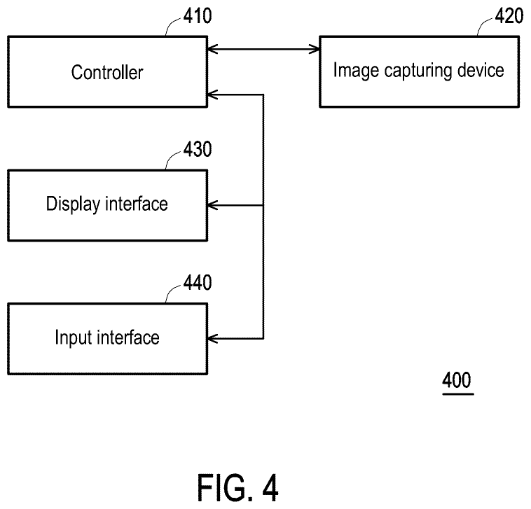

Please refer to FIG. 4 below. FIG. 4 is a schematic view of an electronic device according to an embodiment of the present disclosure. The electronic device 400 includes a controller 410, an image capturing device 420, a display interface 430 and an input interface 440. The controller 410 is coupled to the image capturing device 420, the display interface 430 and the input interface 440. The controller 410 may be used to perform multiple steps in the processes shown in FIG. 1 to FIG. 3. The controller 410 may be designed using Hardware Description Language (HDL) or any other digital circuit design method known to those of ordinary skill in the art, and may be hardware implemented through Field Programmable Gate Array (FPGA), Complex Programmable Logic Device (CPLD) or Application-specific Integrated Circuit (ASIC).

The image capturing device 420 may be a camera, or other device that is well known to those of ordinary skill in the art and may capture still or dynamic images, and there is no particular limitation.

It is worth mentioning that the display interface 430 and the input interface 440 may be two independent devices, or they may also be integrated devices. In an embodiment of the present disclosure, the input interface 440 may be a touch interface of any form, and is integrated with the display interface 430. In this way, the user may input commands by performing a touch operation on the input interface 440. In another embodiment of the present disclosure, the input interface 440 may be any input device known to those of ordinary skill in the art, such as a keyboard or a mouse, and may not be integrated with the display interface 430. In the embodiment of the present disclosure, the display interface 430 may be a display of any form, and there is no fixed limitation.

To sum up, in the image capturing control method of the present disclosure, by providing the user with the option of selected capturing algorithms and allowing the user to perform the setting operation on the algorithm parameters of the selected capturing algorithm, it is possible to increase the freedom for the user to perform image capturing operations to obtain more creative output images.

Finally, it should be noted that the above embodiments are only used to illustrate the technical solution of the present disclosure, but not to limit it. Although the present disclosure has been described in detail with reference to the foregoing embodiments, those of ordinary skill in the art should understand that: The technical solutions described in the foregoing embodiments can still be modified, or some or all of the technical features can be equivalently replaced; and these modifications or substitutions do not deviate from the essence of the corresponding technical solutions from the scope of the technical solution in the embodiments of the present disclosure.

What is claimed is:

1. An image capturing control method comprising:
providing a plurality of candidate capturing algorithms;
setting one of the plurality of candidate capturing algorithms as a selected capturing algorithm;
setting a plurality of algorithm parameters of the selected capturing algorithm according to a first input command;
performing an image capturing operation of N image frames to obtain a plurality of captured images according to the plurality of algorithm parameters, wherein N is a positive integer; and
performing an image processing operation on the plurality of captured images according to the plurality of algorithm parameters to generate an output image.

2. The image capturing control method according to claim 1, wherein the step of providing the plurality of candidate capturing algorithms comprises:
providing a display interface to display the plurality of candidate capturing algorithms.

3. The image capturing control method according to claim 1, wherein the step of setting one of the plurality of candidate capturing algorithms as the selected capturing algorithm comprises:
receiving a second input command, and selecting one of the plurality of candidate capturing algorithms as the selected capturing algorithm according to the second input command.

4. The image capturing control method according to claim 1, wherein before the step of setting the plurality of algorithm parameters of the selected capturing algorithm according to the first input command, the method further comprises:
providing a display interface to display the plurality of algorithm parameters; and
providing an input interface to receive the first input command.

5. The image capturing control method according to claim 1, further comprising:
performing a preview operation on a capturing scene, and generating the plurality of candidate capturing algorithms according to the capturing scene.

6. The image capturing control method according to claim 1, wherein the plurality of candidate capturing algorithms comprise at least one of a high dynamic range algorithm and a night capturing algorithm.

7. The image capturing control method according to claim 6, wherein when the selected capturing algorithm is the high dynamic range algorithm, the plurality of algorithm parameters comprise the number of the plurality of captured images respectively corresponding to a plurality of exposure values.

8. An electronic device, comprising:
an image capturing device; and
a controller coupled to the image capturing device, and disposed to:
provide a plurality of candidate capturing algorithms;
set one of the plurality of candidate capturing algorithms as a selected capturing algorithm;
set a plurality of algorithm parameters of the selected capturing algorithm according to a first input command;
perform an image capturing operation of N image frames through the image capturing device to obtain a plurality of captured images according to the plurality of algorithm parameters, wherein N is a positive integer; and
perform an image processing operation on the plurality of captured images according to the plurality of algorithm parameters to generate an output image.

9. The electronic device according to claim 8, further comprising:
a display interface coupled to the controller and displaying the plurality of candidate capturing algorithms.

10. The electronic device according to claim 9, further comprising:
an input interface coupled to the controller for receiving the first input command and a second input command,
wherein the controller selects one of the plurality of candidate capturing algorithms as the selected capturing algorithm according to the second input command.

11. The electronic device according to claim 10, wherein the controller performs a preview operation on a capturing scene through the image capturing device, and the controller generates the plurality of candidate capturing algorithms according to the capturing scene.

12. The electronic device according to claim 8, wherein the plurality of candidate capturing algorithms comprise a high dynamic range algorithm and a night capturing algorithm.

13. The electronic device according to claim 12, wherein when the selected capturing algorithm is the high dynamic range algorithm, the plurality of algorithm parameters comprise the number of the plurality of captured images respectively corresponding to a plurality of exposure values.
